(19) United States
(12) Patent Application Publication
(10) Pub. No.: US 2007/0069891 A1
(43) Pub. Date: Mar. 29, 2007

(54) Child locator

(76) Inventors: David B. Wallace, Salt Lake City, UT (US); Metin Gunsay, Draper, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/237,559

(22) Filed: Sep. 28, 2005

(51) Int. Cl. G08B 1/08

(52) U.S. Cl. 340/539.15

(57) ABSTRACT

A child locator device which is more user friendly and provides increased reliability and efficiency of operation than previously provided child locator devices. The child locator device is configured to be miniaturized to have an overall less obtrusive design. Miniaturization is provided by one or more of a coin cell battery, a transformer, and a microprocessor. The child locator device includes an anti-tamper device, which prevents the child or a potential abductor from removing the child locator device by actuating an alarm when the child locator device is tampered with or otherwise removed from the wearer. The child locator device system can be configured for a plurality of different receiver units which can be separately activated by the parent/transmitter unit to locate individual children wearing different receiver devices.

### BACKGROUND OF THE INVENTION

1. The Field of the Invention

The present invention relates to a child locator system. In more particular, the present invention relates to a child locator system for providing visual and audible indication of the location of a child.

2. The Relevant Technology

In modern society a variety of dangers are present to children both in the home and also outside the home. One danger that has been of particular concern to parents and society as a whole is lost children and the abduction of children. During the last twenty years, there has been a significant increase of focus on child safety to decrease such dangers. A number of different devices have been developed to prevent the loss of children and to discourage the abduction of children. For example, one simple device comprises a harness that is placed on a child with a leash that can be tied or otherwise secured to the parent. The harness leash device maintains a degree of contact with the child, while also allowing the child some ability to roam.

Another device comprises an alarm which can be actuated by a parent or child to warn a potential abductor or to simply allow the parent to identify the location of the child. While such alarm devices have conceptually been promising as a solution to problems associated with locating a child which is out of the sight of a parent, the usage of such devices has not gained widespread acceptance. This is largely due to impractical aspects of such devices that discourage their effective usefulness with children and/or parents. For example, many such devices are large and bulky. As a result, such devices become a source of irritation to the wearer of such devices. The wearer of such devices, such as small children, often resist using such devices on a regular basis and in the contexts in which the device may be most helpful.

One factor that has contributed to the large and bulky nature of child locator devices is the batteries which are required to operate such devices. Typically, such devices utilize large alkaline batteries, such as a nine volt battery or a plurality of double or triple A-cell batteries. Additionally, the wiring for the components of the child locator devices may be large and cumbersome, adding to the overall size of the design. The combination of the size of the batteries and the associated circuitry has resulted in child location device components that are too large to be regularly utilized by most users. Additionally, such child locator systems typically utilize an alarm that is either too loud or not loud enough for the environment in which a child must be located. For example, where the alarm is not sufficiently loud, in a store or other crowd setting, the parent may not be able to hear the alarm. This can make it difficult if not impossible for a parent to locate the child. Where the alarm is too loud, the alarm may startle the child, further complicating an already delicate situation.

### BRIEF SUMMARY OF THE INVENTION

The present invention is directed to a child locator device which is more user friendly and provides increased reliability and efficiency of operation than previously provided child locator devices. According to one embodiment of the present invention, the child locator device is configured to be miniaturized to have a smaller, lighter, and an overall less obtrusive design. By providing miniaturization of the device, resistance to usage by a child and a parent is decreased. According to another embodiment of the present invention, the child locator device includes an anti-tamper device, which prevents the child or a potential abductor from removing the child locator device by actuating an alarm when the child locator device is tampered with or otherwise removed from the wearer. In another embodiment, the child locator device system includes a plurality of different receiver units which can be separately activated by the parent/transmitter unit to locate individual children wearing different receiver devices.

According to one embodiment of the present invention, a child locator device is provided having a degree of miniaturization resulting in an overall smaller and less obtrusive design of the child locator device. In one embodiment, the overall size of the child locator device is such that the largest dimension is less than 2½ inches. In another embodiment, the largest dimension is less than 1½ inches. In another embodiment, miniaturization of the child locator device is provided by utilizing a coin cell battery to provide power for operation of the child locator device. In another embodiment, the coin cell battery is utilized in connection with a transformer to provide approximately 90 decibels of alarm sound at one meter, which is sufficient to locate the child in crowds or other high noise situations. In another embodiment, the transformer has a one to ten turn ratio to provide approximately 30 volts from a three volt coin cell. In yet another embodiment, the coin cell is provided in connection with a piezo element to provide an alarm sound of approximately 90 decibels at one meter. In yet another embodiment, between 70 and 110 decibels of sound are provided at one meter by the child locator system. In yet another embodiment, a miniaturized circuit board is provided that is less than 1 inch at its greatest dimension and extends across more than half of the largest dimension of the child locator device.

According to another embodiment of the present invention, the child locator system includes an anti-tamper device. According to one embodiment of the present invention, the anti-tamper device prevents the child or potential abductor from removing the anti-tamper device without actuating an alarm on the child locator system. The anti-tamper device warns the parent or other person adjacent the child that the child locator device has been removed and a potentially dangerous situation has been created. According to one embodiment of the present invention, the anti-tamper device can be turned on and off by the parent transmitter unit to allow for selective removal of the child locator device from the child as desired by the parent. In another embodiment, the anti-tamper device is provided on a clip or other securement member of the child locator device. In another embodiment, changes in capacitance of the clip or other securement member are monitored and, where a threshold of change in capacitance is exceeded, an alarm is actuated. In another embodiment, a parent can actuate a secondary danger warning signal or other alarm where the parent senses that a particularly dangerous or sensitive situation has arisen.

According to another embodiment of the present invention, the child locator device system includes a transmitter which controls a plurality of receiver units. A separate signal is provided for each child or receiver unit. The transmitter or parent unit includes a plurality of buttons with each button corresponding with a different child or receiver unit. In yet another embodiment, a toggle screen is provided, allowing a parent to select actuation of a different child unit.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A is a perspective view of a receiver unit of a child locator device, according to one embodiment of the present invention.

FIG. 1B is a perspective view of a transmitter unit for use with the receiver unit of FIG. 1A, according to one embodiment of the present invention.

FIG. 2 is a perspective view of a child locator system being utilized in a typical use environment, according to one embodiment of the present invention.

FIG. 3A is a perspective view of a receiver unit 12 attached to a child, according to one embodiment of the present invention.

FIG. 3B is a perspective view of a receiver unit being removed from a child and an anti-tamper device being actuated, according to one embodiment of the present invention.

FIG. 4 is a bottom view showing the internal components of the child locator system, according to one embodiment of the present invention.

FIG. 5 is an exploded view of the transmitter unit showing the internal components of the transmitter unit, according to one embodiment of the present invention.

FIG. 6 is a schematic view of the circuitry of a transmitter unit according to one embodiment of the present invention.

FIG. 7 is a schematic of the receiver unit, according to one embodiment of the present invention.

### DETAILED DESCRIPTION OF THE PREFERRED EMBODIMENTS

The present invention is directed to a child locator device which is more user friendly and provides increased reliability and efficiency of operation than previously provided child locator devices. According to one embodiment of the present invention, the child locator device is configured to be miniaturized to have an overall less obtrusive design. By providing miniaturization of the device, resistance to usage by a child and/or a parent is decreased. According to another embodiment of the present invention, the child locator device includes an anti-tamper device, which prevents the child or a potential abductor from removing the child locator device by actuating an alarm when the child locator device is tampered with or otherwise removed from the wearer. In another embodiment, the child locator device system includes a plurality of different receiver units which can be separately activated by the parent/transmitter unit to locate individual children wearing different receiver devices.

According to one embodiment of the present invention, a child locator device is provided having a degree of miniaturization resulting in an overall smaller and less obtrusive design of the child locator device. In one embodiment, the overall size of the child locator device is such that the largest dimension is less than 2½ inches. In another embodiment, the largest dimension is less than 1½ inches. In another embodiment, miniaturization of the child locator device is provided by utilizing a coin cell battery to provide power for operation of the child locator device. In another embodiment, the coin cell battery is utilized in connection with a transformer to provide approximately 90 decibels of alarm sound at one meter, which is sufficient to locate the child in crowds or other high noise situations. In another embodiment, the transformer has a one to ten turn ratio to provide approximately 30 volts from a three volt coin cell. In yet another embodiment, the coin cell is provided in connection with a piezo element to provide an alarm sound of approximately 90 decibels at one meter. In yet another embodiment, between 70 and 110 decibels of sound are provided at one meter by the child locator system. In yet another embodiment, a miniaturized circuit board is provided that is less than 1 inch at its greatest dimension and extends across more than half of the largest dimension of the child locator device.

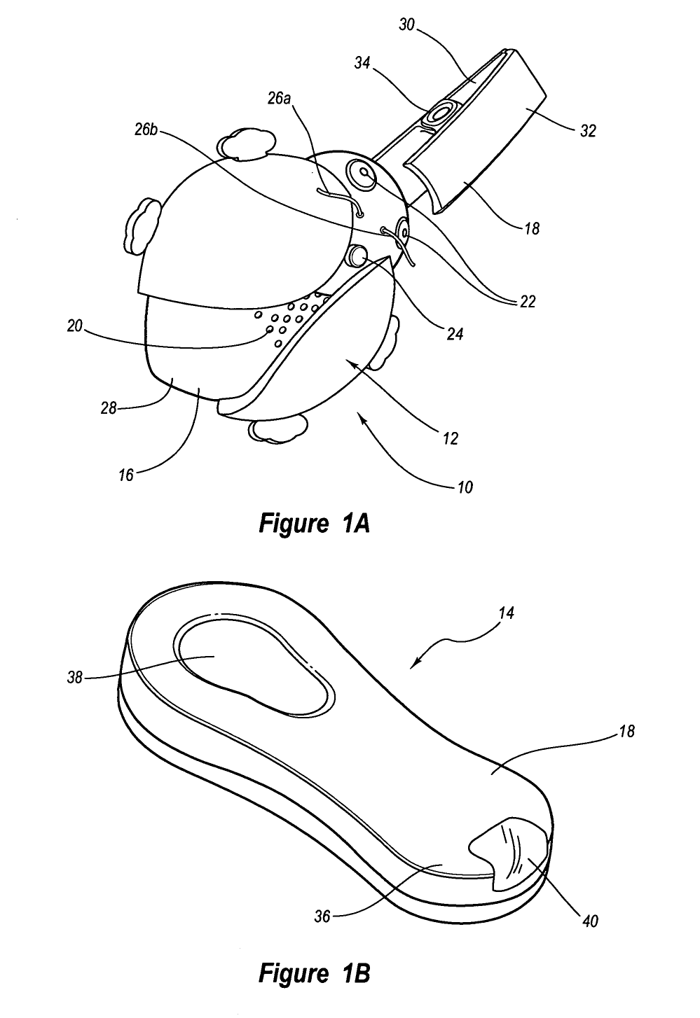

FIG. 1 is a perspective view of receiver unit 12 of a child locator system 10, according to one embodiment of the present invention. Receiver unit 12 is configured to be attached to or otherwise secured to a child to provide an indication of the location of the child should the child become lost or be out of sight of the parent. In the illustrated embodiment, receiver unit 12 includes a housing 16, a clip 18, an audible indicator 20, a visual indicator 22, a tester button 24, and antennas 26a, b. In the illustrated embodiment, receiver unit 12 is provided with the ornamental design of a bug to encourage wearing of the child locator unit by the child.

Housing 16 comprises an outer protective shell for containing the other components of the receiver unit 12. Additionally, housing 16 provides much of the ornamental design of the receiver unit 12. A clip 18 is attached to the upper end of housing 16. Clip 18 is configured to secure a receiver unit to a child or the child's clothing in a manner that it will remain attached to the child during normal usage of the child locator system 10. In the illustrated embodiment, clip 18 includes base portion 30 and a moveable portion 32. Base portion 30 is securely attached to housing 16. Moveable portion 32 is hingedly attached to base portion 30 by use of a hinge 34. A user depresses the rear end of moveable portion 32 to bias the hinge 34 and create separation between the tips of base portion 30 and moveable portion 32. This allows the clip 18 to be attached to the belt, dress, or other vesture of the child for which the receiver unit is utilized. As the user releases the rear end of the moveable portion 32, a bias spring of the hinge 34 biases the front end of moveable portion 32 adjacent the tip of base portion 30, effectively securing clip 18 to the child.

A plurality of speaker bores are associated with audible indicator 20. Audible indicator 20 allows for the emanation of audible signals from the receiver unit 12 in response to actuation of the receiver unit 12 by the transmitter 14 (shown in FIG. 1B). In the illustrated embodiment, audible indicator 20 comprises a speaker unit utilizing a piezo element to provide an audible signal indicating the location of the child subsequent to actuation of the transmitter 14.

Visual indicators 22 are provided in connection with receiver unit 12. Visual indicators 22 comprise LEDs located within housing 16. In the illustrated embodiment, when audible indicator 20 is actuated, visual indicators 22 also are actuated providing both audible and visual indication of the location of the child. In some contexts, where a large amount of noise or other environmental distractions may prevent detection of the audible indicator, a direct line of sight may allow a parent to detect the actuation of the LEDs of visual indicator 22. In the illustrated embodiment, visual indicators 22 are positioned so as to simulate the eyes of the ornamental bug of housing 16.

Tester button 24 is positioned approximately at the center of housing 16. Tester button 24 allows a parent to determine whether there is sufficient battery power to allow actuation of receiver unit 12. According to an alternative embodiment, tester button 24 allows a user to turn on or off different aspects of the receiver unit, such as the alarm, the visual indicators, the anti-tamper device, or other components of the receiver unit. Antennas 26a, b are attached to the portion of housing 16 corresponding with the head portion of the ornamental bug. One of antennas 26a, b comprise a receiver antenna for detecting RF or other signals sent from transmitter 14 (see FIG. 1B) to receiver unit 12. The other of the antennas 26a, b comprises a purely ornamental member which minimizes distraction that may be provided by a single antenna 26a, b. In the illustrated embodiment, a removable end portion 28 is provided. Removable end portion 28 allows a user to remove a portion of housing 16 to access the coin cell or other battery for replacement or to monitor other components of the receiver unit circuitry.

As will be appreciated by those skilled in the art, a variety of types and configurations of receiver units can be provided without departing from the scope and spirit of the present invention. For example, in one embodiment, a lanyard is provided to secure the child locator receiver unit to the child. In another embodiment, only an audible indicator is provided with no visual indicator. In yet another embodiment, the receiver antenna is positioned within the housing of the receiver unit. In another embodiment, the tester button is provided to actuate or deactuate the anti-tamper device. In another embodiment, an internal antenna is utilized in place of the exterior antennas. In another embodiment, both of the antennas on the exterior of the child locator device provide antenna functionality.

FIG. 1B is a perspective view of a transmitter 14, according to one embodiment of the present invention. In the illustrated embodiment, transmitter 14 is held by the parent to provide actuation of the audible and/or visual indicator of the receiver unit 12 (see FIG. 1A). In the illustrated embodiment, transmitter 14 comprises a body 36, an alarm button 38, and securement ring 40. Body 36 contains the internal components of transmitter 14 while providing protection to the internal components of transmitter 14. Body 36 has an ergonomical design, providing for a desired and comfortable placement of transmitter 14 in the user's palm. Alarm button 38 is positioned on the upper side of transmitter 14. A user depresses alarm button 38 to actuate the audible and/or visual indicators of the receiver unit to locate the child.

Securement ring 40 is positioned at one end of the body 36 of transmitter 14, such that it can be hooked or secured by a lanyard or other attachment to a key ring, a parent's purse, a parent's clothes, or in another optimized and desired location. As will be appreciated by those skilled in the art, a variety of types and configurations of transmitters can be provided without departing from the scope and spirit of the present invention. For example, in one embodiment, the transmitter is provided with an antenna to increase power transmission of an RF signal to a receiver unit. In another embodiment, the transmitter includes a plurality of buttons allowing for different optimization of signals and alarms from the receiver unit. In yet another embodiment, a button is provided on the transmitter to actuate or to deactuate an anti-tamper device of the receiver unit, according to one embodiment of the present invention.

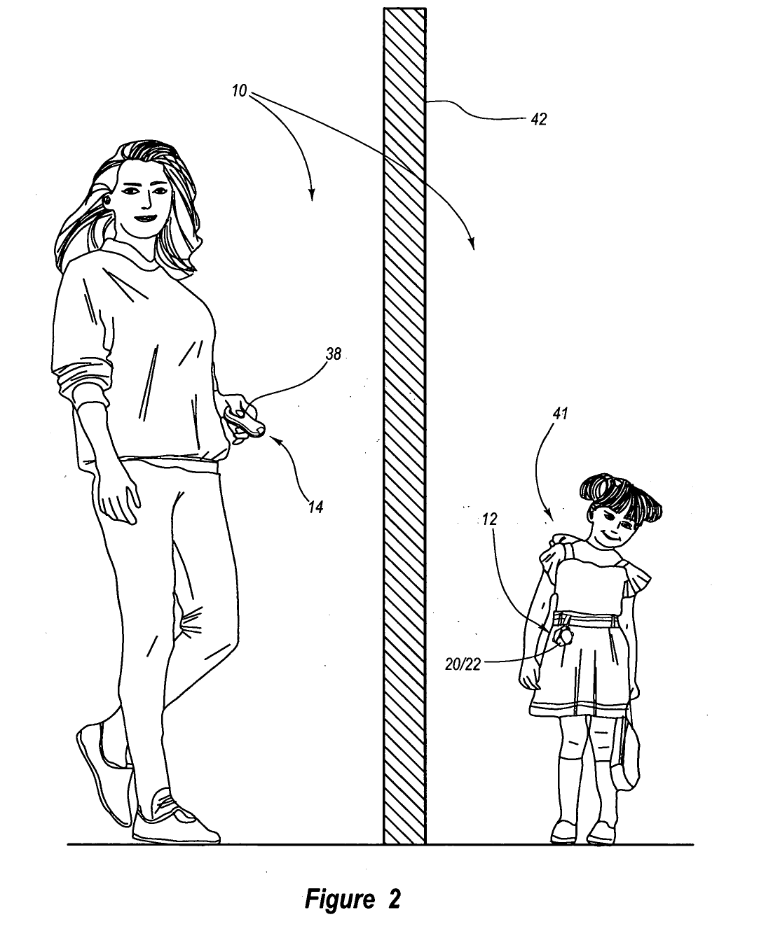

FIG. 2 is a perspective view of an environment in which a child locator 10 can be utilized according to one embodiment of the present invention. In the illustrated embodiment, a mother is shown holding a transmitter 14. A child is shown wearing a receiver unit 12 and is separated from the mother by an obstacle 42. In the event that the child becomes separated from the parent from visual contact, such as by obstacle 42, the parent can simply depress alarm button 38 on transmitter 14 to actuate the audible indicator and visual indicator 20 and 22 of receiver unit 12. In the event that the parent depresses the alarm button 38 of transmitter 14, the audible indicator 20 and the visual indicator 22 are actuated. Thus, the parent can sense the direction of sound of the audible indicator 20 and potentially see the flashing visual indication of visual indicator 22. Detection of the audible indicator 20 and visual indicator 22 allow the parent to be able to quickly and readily identify the location of the child. In this manner, the sense of urgency and fear that can be associated with the loss of a child may quickly become dissipated by the quick and ready location of the child through the use of the receiver unit 12.

In the illustrated embodiment, the audible indicator 20 of receiver unit 12 provides between 70 and 110 decibels of sound at one meter to be able to readily identify the location of the child within a crowd or other noisy environment. For example, in one embodiment, the audible indicator 20 of receiver unit 12 provides approximately 90 decibels of sound at one meter. By providing 90 decibels of sound at one meter, a parent can easily determine the location of the child, even when separated by obstacles or in ambient noise conditions such as a mall, store, or park. By providing 90 decibels of sound at one meter, such potential additional interference and sounds do not interfere with quick and proper location of the child when the audible indicator unit 20 of the receiver unit 12 is actuated.

As will be appreciated by those skilled in the art, a variety of types and configurations of child locator systems can be utilized without departing from the scope and spirit of the present invention. For example, in one embodiment, a plurality of receiver units are provided for a plurality of children, which can be actuated by a single transmitter, according to one embodiment of the present invention. In another embodiment, the audible indicator of the receiver unit provides over 110 decibels of sound at one meter when actuated by the transmitter. In another embodiment, a secondary, emergency alarm that is louder than the primary locator alarm is provided in dangerous or potential emergency situations. In yet another embodiment, the transmitter is configured to turn on or off an anti-tamper device of the receiver unit.

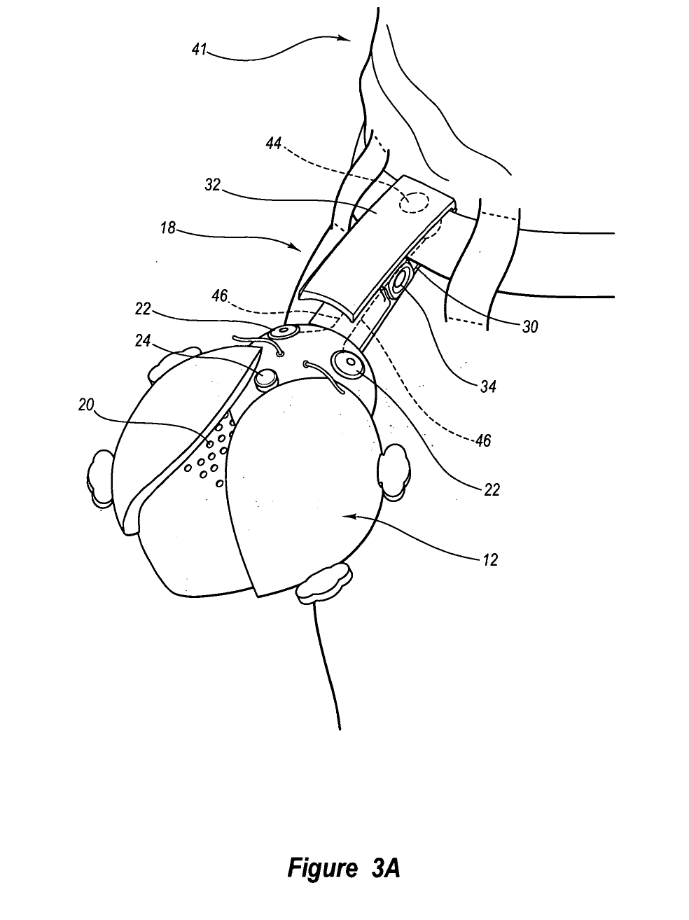

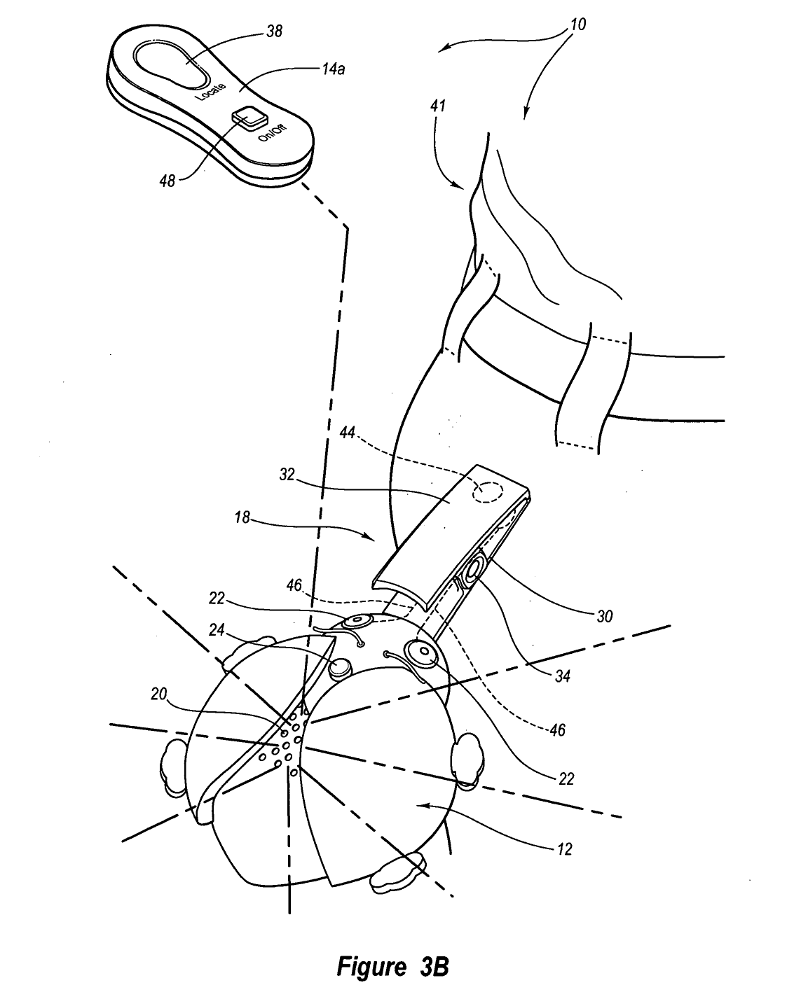

FIG. 3A is a perspective view of receiver unit 12 attached to the belt of a child 41, according to one embodiment of the present invention. In the illustrated embodiment, clip 18 is secured to the belt of child 41, such that base portion 30 is positioned on the underside of the belt and moveable portion 32 is positioned on the upper side of the belt. The contact switch 44 is shown in phantom in the tip of moveable portion 32. Contact switch 44 is provided in connection with a sensor in the tip of base portion 30. Wiring 46 provides a connection between the sensor and contact switch 44, such that an indicator signal is provided to the circuitry of receiver unit 12 to signal that clip 18 is securely fastened about the belt of child 41.

As shown in FIG. 3B, the clip 18 of receiver unit 12 has been removed from the belt of child 41. When clip 18 of receiver unit 12 is removed from the belt of child 41, a temporary separation between contact switch 44 of moveable portion 32 and the sensor of base portion 30 is provided. Such temporary separation is automatically detected by the sensor of base portion 30 and transmitted to the circuitry of receiver unit 12 by wiring 46. This automatically actuates an anti-tamper alarm signal through audible indicator 20. Additionally, visual indicator 22 flashes a warning signal indicating that receiver unit 12 has been removed from child 41. In this manner, in the event that the child attempts to remove the receiver unit 12 from his/her clothing, the parent is apprised of the situation and can replace the child locator system on the child 41. Additionally, in the event that a potential abductor attempts to remove the receiver unit 12 to be able to remove the child from a particular environment undetected, an automatic warning signal is provided to the parent and/or adjacent adults in the vicinity of the child 41.

In the illustrated embodiment, a transmitter 14a is illustrated. Transmitter 14a is provided with an anti-tamper device on/off button 48 in addition to the alarm button 38. Anti-tamper on/off button 48 allows a parent to actuate the anti-tamper device once the clip has been positioned on the child. Additionally, the parent may deactuate the anti-tamper device using the anti-tamper device on/off button 48 when the parent is preparing to remove the receiver unit 12 from the child subsequent to usage of the receiver unit 12 or in order to otherwise attend to the receiver unit 12 such as during replacement of the batteries.

As will be appreciated by those skilled in the art, a variety of types and configurations of anti-tamper devices can be provided without departing from the scope and spirit of the present invention. For example, in one embodiment, the anti-tamper device does not utilize a contact sensor, but instead measures the capacitance between the tip of the moveable portion and the tip of the base portion to determine whether an individual is attempting to remove the receiver unit from the child. In another embodiment, the anti-tamper device determines whether someone is attempting to cut or otherwise remove a lanyard of the receiver unit from the child. In yet another embodiment, an anti-tamper device on/off button is provided directly on the receiver unit, rather than on the transmitter unit.

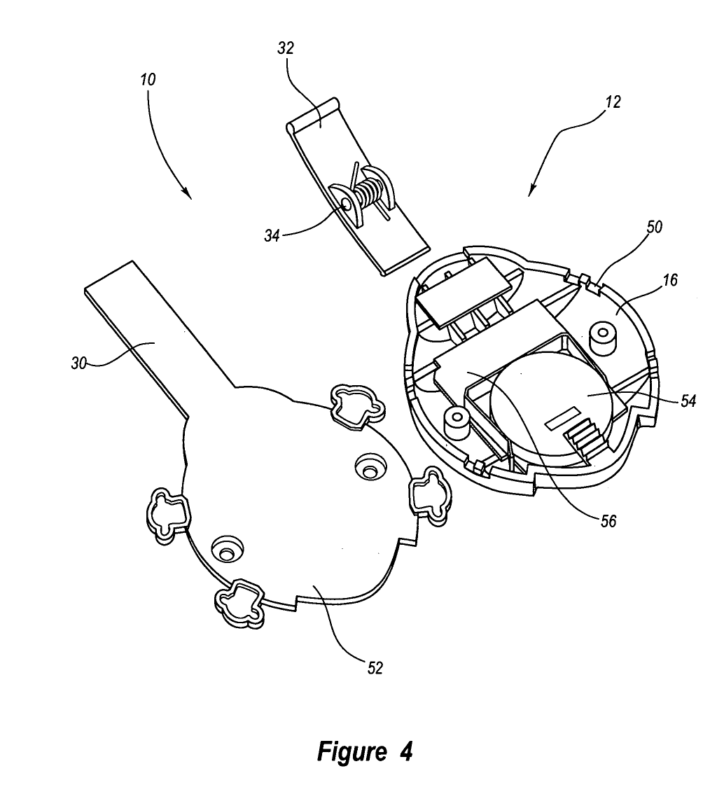

FIG. 4 is bottom perspective view of receiver unit 12 illustrating the internal components of receiver unit 12. In the illustrated embodiment, housing 16 comprises a top portion 50 and a bottom portion 52. Bottom portion 52 is shown removed from top portion 50 illustrating the position of the internal components of receiver unit 12. Base portion 30 of clip 16 is integrally coupled to bottom portion 52 of housing 16. Moveable portion 32 is shown in its position relative to top portion 50 of housing 16, but is not integrally coupled thereto. As previously discussed, moveable portion 32 is coupled to housing 16 by being hingedly coupled to base portion 30 utilizing hinge 34. In the illustrated embodiment, a bias spring is shown secured about hinge 34.

In the illustrated embodiment, a coin cell 54 and a circuit board 56 are shown nestled in the top portion 50 of housing 16. Circuit board 56 extends along more than half of the transverse dimension of the top portion 50. Circuit board 56 provides the control algorithms for allowing transmission of a signal from a transmitter 14 (see FIG. 1B) to receiver unit 12 so as to actuate an audible indicator and visual indicator of receiver unit 12. Coin cell 54 provides power to allow for proper operation of circuit board 56 and the audible indicator and visual indicator of the receiver unit 12. By utilizing a coin cell 54 and a circuit board 56 having a smaller overall dimension, the overall size of receiver unit 12 can be substantially miniaturized, such that a child can wear receiver unit 12 without obtrusive, heavy, or otherwise cumbersome interference of the child's normal activities. In particular, the thickness of circuit board 56 and coin cell 54 is substantially narrower and also lighter than existing child location device designs allowing for an overall improved and smaller and lighter design of child locator system 10.

In the illustrated embodiment, the overall size of the housing 16 of receiver unit 12 is less than 2½ inch in any dimension. In another embodiment, the overall size of the housing 16 and overall receiver unit 12 is less than 1 1/2 inch. In another embodiment, the circuit board is less than 1 inch at its greatest dimension and in the transverse dimension fills more than one half of the child locator device.

As will be appreciated by those skilled in the art, a variety of types of and configurations of child locator devices can be utilized without departing from the scope and spirit of the present invention. For example, in one embodiment, the housing of the child locator system is molded. In another embodiment, a nickel hydride, lithium, or other battery is utilized in the place of the coin cell battery. In another embodiment, circuit wiring replaces the circuit board, while still having the overall small and light dimensions, as provided in connection with the receiver unit.

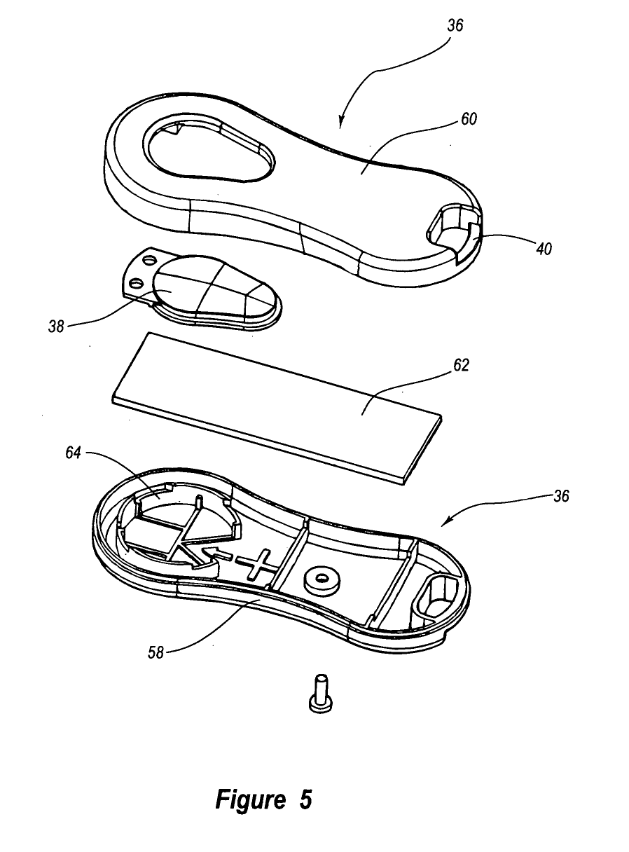

FIG. 5 is an exploded view of the transmitter 14, according to one embodiment of the present invention. In the illustrated embodiment, body 36 comprises a bottom portion 58 and a top portion 60. A circuit board 62 is provided to be sandwiched between the top portion 60 and bottom portion 58 to provide protection for circuit board 62. Circuit board 62 provides the functionality allowing for proper operation of the transmitter 14 in connection with the receiver unit 12. According to one embodiment of the present invention, an RF signal is utilized to transmit a distinct signal to the receiver unit to prevent inadvertent confusion of signals from the transmitter 14 to the receiver unit 12 (see FIG. 1A). According to one embodiment of the present invention, the largest overall dimension of the transmitter unit is less than 2 ½ inches. In another embodiment, the circuit board has a length of less than 1½ inches and fills more than one half of the largest dimension of the transmitter 14. In another embodiment, the transmitter has a length of less than 1½ inches and the circuit board has the length of less than ½ inch. In the illustrated embodiment, bottom portion 58 includes a coin cell holder 64. A coin cell battery is configured to be positioned within coin cell holder 64 to provide power to circuit board 56 and the overall functionality and operation of transmitter 14.

As will be appreciated by those skilled in the art, a variety of types and configurations of transmitters can be utilized without departing from the scope and spirit of the present invention. For example, in one embodiment, a nickel hydride, lithium, or other battery can be utilized in place of the coin cell battery. In another embodiment, circuit wiring is provided in the place of the circuit board. In another embodiment, a plurality of actuation buttons are provided. In another embodiment, the circuit board provides a unique signal to communicate with the receiver unit. In another embodiment, the circuit board is programmable to allow for additional functionality and design than provided by a standard circuit board.

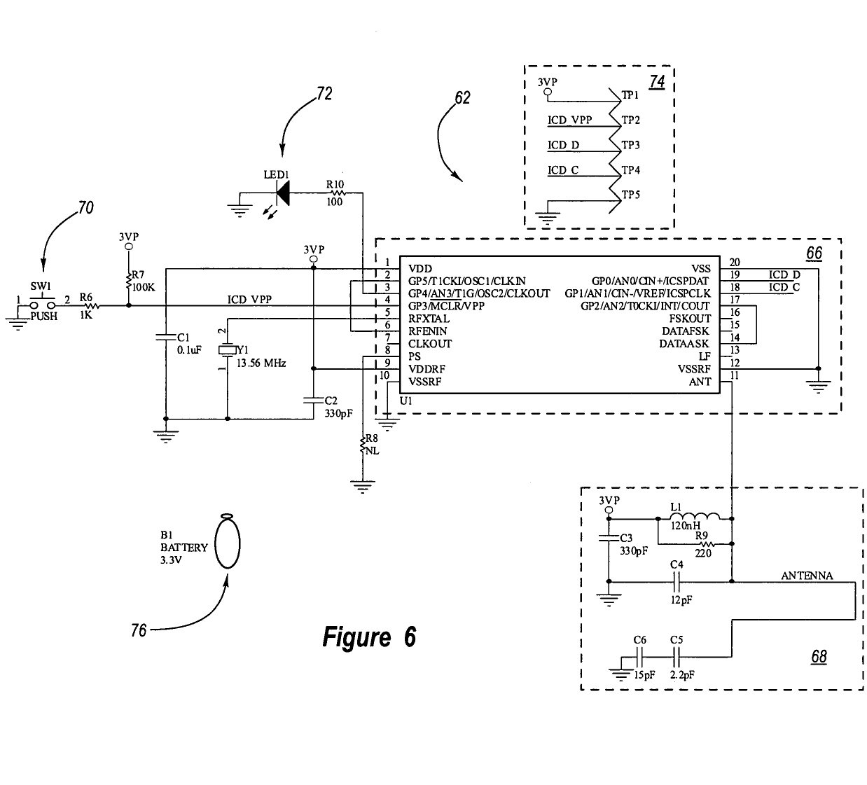

FIG. 6 is a schematic view of the circuit board of transmitter 14, according to one embodiment of the present invention. In the illustrated embodiment, circuit board 62 comprises a microprocessor 66, an antenna 68, a switch 70, and LED actuator 72, RF source 73, programming interface 74, and a battery 76. Circuit board 62 also includes a plurality of other electrical components such as resistors, capacitors and inductors that are used for various signal processing purposes as is well known to one skilled in the art.

In the illustrated embodiment of circuit board 62, microprocessor 66 controls the overall functionality and operational design of transmitter 14. For example, microprocessor 66 allows for the transmission of RF signals from the transmitter to the receiver unit 12 (see FIG. 1A), in a manner that allows for actuation of audible and/or visual indications from the receiver unit. Microprocessor 66 is also configured to provide general clock signals for circuit board 62 and to provide other signal processing.

According to one embodiment of the present invention, microprocessor 66 is configured to provide a unique transmission frequency and/or other transmission signal to allow for proper transmission between the receiver unit and transmitter without confusion of other receiver units within the same operating environment. For example, microprocessor 66 receives a desired transmission carrier signal of frequency, such as 433 MHz, from RF source 73. RF source 73 is a stable crystal frequency source known to those skilled in the art that is configured to produce a transmission carrier signal of a desired frequency. Microprocessor 66 then encodes onto the received transmission carrier signal transmission data for receiver 12. The encoded RF signal is provided to other elements of circuit board 62, specifically antenna 68.

Antenna 68 is operably coupled to microprocessor 66. Antenna 68 is provided for the transmission of an encoded RF signal from transmitter 14 to receiver; unit 12. Antenna 68 can be any antenna known to one skilled in the art that is small enough to fit the desired compact size of transmitter 14. For example, antenna 68 can be a micro strip patch antenna that is appropriately sized and configured for the desired transmit frequency. Antenna 68 can also be a wire dipole antenna that is appropriately sized and configured. A variety of types and configurations of implementation of antenna 68 can be utilized within the scope and spirit of the present invention.

Switch 70 allows the user to provide an input signal to cause microprocessor 66 to send a signal to receiver unit 12, in order to actuate audible and visual indictors of receiver unit 12. In the illustrated embodiment, switch 70 comprises a push-type contact switch, which, when pushed by a user, automatically sends a signal to microprocessor 66, causing microprocessor 66 to encode data onto the carrier signal and to provide the encoded signal to antenna 68 and then to receiver unit 12. As will be appreciated by those skilled in the art, a variety of types and configurations of switches can be utilized without departing from the scope and spirit of the present invention. For example, in one embodiment switch 70 may be single pull switch, that when flipped from an “off” position to an “on” position causes a signal to be sent to microprocessor 66. In other embodiments, switch 70 can be a sliding switch that when slid from an “off” position to an “on” position causes a signal to be sent to microprocessor 66. In further embodiments, the switch 70 may be any other type of commonly known switch with the functionality of the switches already described.

An LED actuator 72 is provided in connection with circuit board 62. LED actuator 72 actuates an LED light subsequent to depression of switch 70 by a user. Operation of LED actuator 72 is controlled through the input/output functionality provided by microprocessor 66. Microprocessor 66 activates actuator 72 upon receiving the input signal when switch 70 is pushed by a user as described previously. When the user discontinues pushing switch 70, the microprocessor 66 deactivates LED actuator 72. Accordingly, the LED light is only activated when a user is operating transmitter 14.

The programming interface 74 is provided in connection with microprocessor 66. Programming interface 74 allows for programming and control codes to be programmed into microprocessor 66 to provide for the desired control and functionality of microprocessor 66. Use of programming interface 74 ensures that desired control codes are implemented by microprocessor 66. The programming interface 74 includes a number of test points that allow an external programming device to be coupled to microprocessor 66 during a programming operation. Microprocessor 66 can be programmed by any method or technique known to one skilled in the art.

Battery 76 is provided to power the components of circuit board 62. In the illustrated embodiment, battery 76 comprises a 3.3 volt coin cell. Battery 76 can also be any other type of commonly known battery with sufficient voltage to power the various components of circuit board 62. Power inputs are provided at a number of positions within circuit board 62, including a position between switch 70 and microprocessor 66, programming interface 74, and antenna 68.

As will be appreciated by those skilled in the art, a variety of types and configurations of circuit boards can be utilized without departing from the scope and spirit of the present invention. For example, in one embodiment, the microprocessor is replaced by logic circuitry. In another embodiment, the circuit board includes a plurality of microprocessors to control different aspects of the transmitter control. In anther embodiment, a secondary switch corresponding with an anti-tamper control is provided.

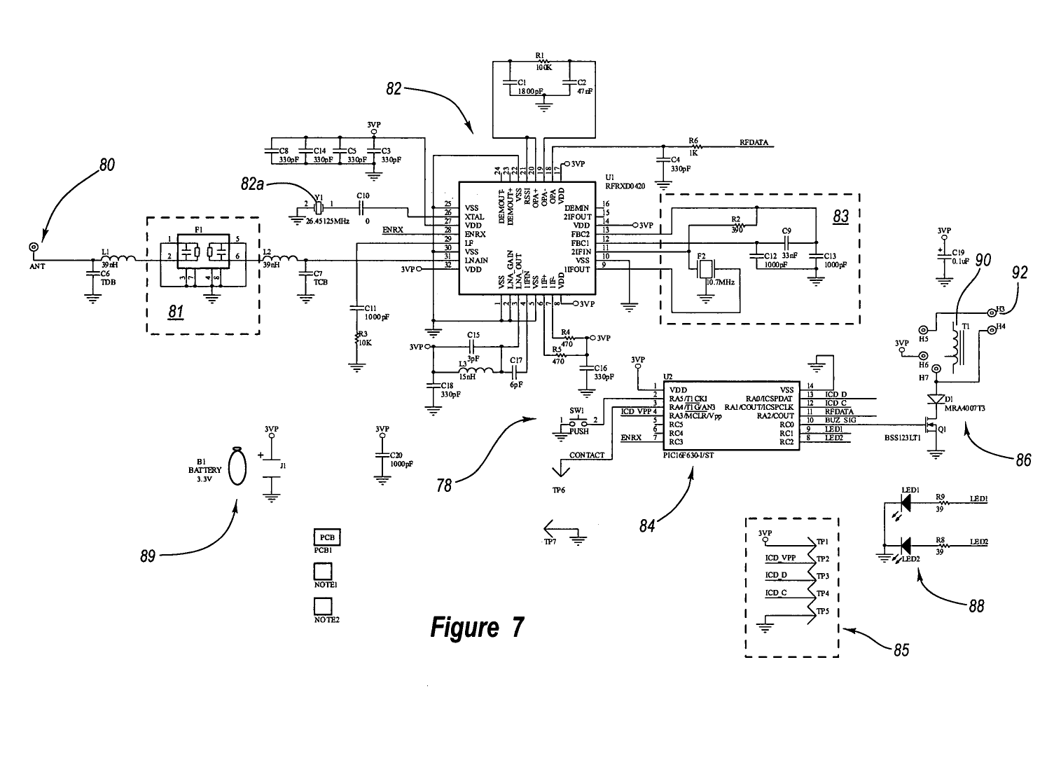

FIG. 7 is a schematic diagram of the circuit board 56 of the receiver unit, according to one embodiment of the present invention. In the illustrated embodiment, circuit board 56 comprises an on/off switch 78, a receiver antenna 80, an input filter 81, an RF controller 82, a signal mixing filter 83, a secondary microcontroller 84, a programming unit 85, a speaker unit 86, an associated transformer 90, a piezo element 92, an LED 88, and a battery 89. Circuit board 56 also includes a plurality of other electrical components such as resistors, capacitors and inductors that are used for various signal processing purposes as is well known to one skilled in the art.

In the illustrated embodiment, on/off switch 78 allows the user to actuate or deactuate the receiver unit to conserve battery power when the child locator system is not being utilized. In the illustrated embodiment, on/off switch 78 comprises a push-type contact switch, which, when pushed by a user, automatically sends a signal to secondary microcontroller 84, causing microcontroller 84 to change the state of the receiver unit 12 from an “off” state to an “on” state if the receiver was originally in an “off” state or to change from an “on” state to an “off” state if the receiver was originally in an “on” state. As will be appreciated by those skilled in the art, a variety of types and configurations of switches can be utilized without departing from the scope and spirit of the present invention. For example, in one embodiment switch 78 can be a single pull switch. In other embodiments, switch 78 can be a sliding switch.

Receiver antenna 80 is configured to receive RF signal that has been sent from the transmitter 14 (see FIG. 6) to the circuit board 56 of the receiver unit. Receiver antenna 80 can be any antenna known to one skilled in the art that is small enough to fit the desired compact size of receiver 12. For example, antenna 80 can be a micro strip patch antenna that is appropriately sized and configured for the desired transmit frequency. Antenna 80 can also be a wire dipole antenna that is appropriately sized and configured.

An input filter 81 is operably coupled to the receiver unit to filter the RF signal received from the receiver antenna 80. As mentioned, input filter 81 filters the incoming RF signal received by antenna 80. In addition, filter 81 serves to match the impedance of antenna 80 to the input of RF controller 82. In some embodiments, filter 81 can also include an amplifier that is used to amplify the received RF signal. In the illustrated embodiment, input filter 81 is a Surface Acoustic Wave (SAW) filter. A variety of types and configurations of input filters can be utilized within the scope and spirit of the present invention.

Once the filter 81 has filtered and/or amplified the signal received by antenna 80, the signal is sent to an input node of the RF controller 82. RF controller 82 comprises a signal processor that allows for further signal processing of the RF signal received from the transmitter circuitry. The RF controller 82 operates in connection with the signal mixing filter 83. Specifically, frequency crystal 82a produces an Intermediate Frequency (IF) signal that is provided to RF controller 82. The IF signal is then mixed with received RF signal by the signal mixing filter 83. Filter 83 can also filter the IF signal and the mixed signal. The mixing and filtering of an IF signal and a transmission signal is well known in the art. This mixing is performed to more easily parse the received transmission signal for instructions.

Once RF controller 82 has parsed the transmission signal, RF controller 82 generates a square wave (i.e., a signal comprising a series of high and low signal components) for transmission to secondary microcontroller 84 as illustrated by the RFDATA output of RF controller 82 and input of secondary microcontroller 84. Secondary microcontroller 84 comprises a digital microcontroller or bit stream controller, which can digitally interpret the square wave and provide the square wave to control speaker unit 86 and LED 88 to provide audible and visual indications to a user in the form of sound and light. Secondary microcontroller 84 also performs other control functions for circuit board 56 such as controlling the on/off function as previously described.

The programming interface 85 is provided in connection with secondary microcontroller 84. Programming interface 85 allows for programming and control codes to be programmed into secondary microcontroller 84 to provide for the desired control and functionality of secondary microcontroller 84. Use of programming interface 85 ensures that desired control codes are implemented by secondary microcontroller 84. The programming interface 85 includes a number of test points that allow an external programming device to be coupled to secondary microcontroller 84 during a programming operation. Secondary microcontroller 84 can be programmed by any method or technique known to one skilled in the art.

The battery 89 is provided in connection with circuit board 56. In the illustrated embodiment, battery 89 comprises a 3.3 volt coin cell battery, which provides power to control operation of circuit board 56 to provide audible and visual indications to a user. Battery 89 can also be any other type of commonly known battery with sufficient voltage to power the various components of circuit board 56. For example, a 1.5 volt coin cell battery can be provided with a transformer having a turn ratio which provides the desired output voltage. Power inputs are provided at a number of positions within circuit board 56.

As mentioned previously, secondary microcontroller 84 provides a transmit signal to LED 88. In the illustrated embodiment, LED 88 comprises two separate LEDs. In other embodiments, one or a plurality of LEDs can be utilized. The LED 88 is activated whenever secondary controller 84 provides the transmit signal. In this manner, a visual indication is provided to a user.

As mentioned previously, secondary microcontroller 84 also provides a transmit signal to speaker unit 86 as illustrated by the BUZ_SIG signal. Speaker unit 86 is configured to provide an audio indication of the received signal in the form of sound. To accomplish this, speaker unit 86 implements a transformer 90 and a piezo element 92. Speaker unit 86 also includes a diode that is configured to absorb excess voltage created by transformer 90 and thus acts as a surge protector by preventing the excess voltage from damaging other components of circuit board 56.

In the illustrated embodiment, battery 89 is connected to a transformer 90 as illustrated by connection H5 and H7. Transformer 90 comprises a one-to-ten turn ratio autotransformer. Accordingly, transformer 90 converts the voltage from coin cell battery 89 from 3 volts to approximately 30 volts. Use of the transformer 90 advantageously allows for the high voltage output necessary to power piezo element 92 while still being able to implement receiver 12 as the small, compact unit suitable to be worn by a child. In other embodiments, transformer 90 can have a turn ratio of between 1 to 5 and 1 to 25 as required by the necessary voltage.

In the illustrated embodiment, the audio sound is produced by piezo element 92. Piezo element 92 consists of a small piezoceramic plate and electrode enclosed in an enclosure that is designed to resonate at the operational frequencies of the element. In addition, circuitry is added to provide a tone at a desired frequency. Piezo element 92 requires a high voltage for operation, which is provided by transformer 90 as previously described. In the illustrated embodiment, piezo element 92 has approximately 90 decibels of output volume at one meter.

As will be appreciated by those skilled in the art, a variety of types and configurations of circuit boards can be provided without departing from the scope and spirit of the present invention. For example, in one embodiment, a single controller is provided to both interpret an incoming transmission from the transmitter and to control operation of audible indicators and visual indicators. In another embodiment, an audible indication is provided by something other than a piezo element, for example a speaker. In yet another embodiment, the voltage supplied to the Piezo is generated from a switching regulator circuit such as a boost converter, rather than the use of a transformer. In another embodiment, the transformer comprises a microcoil. In another embodiment, the transformer comprises an autotransformer. In yet anther embodiment, an additional microcontroller is provided to control operation of an anti-tamper device.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A receiver unit of a child locator system for allowing a parent to identify the location of a child in a home or public environment, the child locator system having a transmitter to allow a parent to send a signal to actuate the receiver unit, the receiver unit providing an alarm in response to transmission of the signal from the transmitter of the child locator system, the receiver unit comprising:
a housing adapted to secure one or more components of the receiver unit;
a receiver antenna configured to receive a transmitted signal from an external source;
a microcontroller having circuitry for processing one or more signals received from the receiver antenna;
an audible indicator operably coupled to the microcontroller such that the audible indicator is actuated in response to a signal received at the receiver antenna;
a miniaturized battery adapted to provide power to the audible indicator to allow for actuation of the audible indicator; and
a current transformer unit coupled to the miniaturized battery and the audible indicator such that voltage derived from the miniaturized battery is increased to provide sufficient voltage to the audible indicator.

2. The receiver unit of claim 1, wherein the voltage transformer unit comprises a transformer.

3. The receiver unit of claim 1, wherein current transformer unit comprises a micro transformer.

4. The receiver unit of claim 2, wherein the transformer provides a turn ratio of between one to five and one to twenty five.

5. The receiver unit of claim 4, wherein the turn ratio of the transformer comprises a one to ten turn ratio.

6. The receiver unit of claim 5, wherein the miniaturized battery comprises an at least one volt coin cell battery.

7. The receiver unit of claim 6, wherein the coin cell battery comprises an at least 2.5 volt coin cell and wherein the one to ten turn ratio of the transformer provides 30 volts to the audible indicator.

8. The receiver unit of claim 1, wherein the audible indicator comprises a speaker.

9. The receiver unit of claim 1, wherein the audible indicator comprises a piezo device.

10. The receiver unit of claim 1, wherein the audible indicator provides an audible signal of between 70 and 120 decibels at one meter.

11. The receiver unit of claim 10, wherein the audible indicator provides an audible signal of between 80 and 100 decibels at one meter.

12. The receiver unit of claim 11, wherein the audible indicator provides an audible signal of 90 decibels at one meter.

13. A receiver unit of a child locator system for allowing a parent to identify the location of a child in a home or public environment, the child locator system having a transmitter to allow a parent to send a signal to actuate the receiver unit and the receiver unit to provide an alarm in response to transmission of the signal from the transmitter of the child locator system, the receiver unit comprising:
a receiver antenna adapted to receive a transmitted signal from an external source;
a microcontroller configured to process one or more signals received from the receiver antenna;
an audible indicator operably coupled to the microcontroller such that the audible indicator is actuated in response to a signal received at the receiver antenna so as to provide at least 80 decibels of sound at one meter when actuated;
a coin cell battery adapted to provide voltage to the audible indicator to allow for actuation of the audible indicator; and
a transformer coupled to the coin cell battery and the audible indicator such that voltage derived from the coin cell battery is transformed to provide sufficient voltage to the audible indicator to provide at least 80 decibels of sound at one meter.

14. The receiver unit of claim 13, wherein further comprising a housing having a greatest dimension of less than 2½ inches.

15. The receiver unit of claim 14, wherein the greatest dimension of the housing is less than 1½ inches.

16. The receiver unit of claim 13, wherein the weight of the receiver unit is less than 10 ounces.

17. The receiver unit of claim 13, further comprising a visual indicator for indicating the location of a child wearing the receiver unit.

18. The receiver unit of claim 17, wherein the both the visual indicator and the audible indicator are actuated in response to a signal received at the receiver antenna.

19. The receiver unit of claim 13, wherein the coin cell battery comprises at least a 2.5 volt coin cell battery.

20. The receiver unit of claim 19, wherein the transformer converts voltage from the at least 3 volt coin cell battery to 30 volts of electricity.

21. A child locator system having a transmitter to allow a parent to send a signal to actuate the receiver unit and a receiver unit to provide an alarm in response to transmission of the signal from the transmitter of the child locator system, the child locator system comprising:
a receiver unit adapted to be secured to a child or child's clothing, the receiver unit comprising:
a miniaturized housing for containing or otherwise securing one or more component of the receiver unit, wherein the greatest dimension of the receiver unit is less than 2½ inches;
a receiver antenna for receiving a transmitted signal from an external source;
a microcontroller for processing one or more signals received from the receiver antenna;
an audible indicator operably coupled to the microcontroller such that the audible indicator is actuated in response to a signal received at the receiver antenna so as to provide at least 80 decibels of sound at one meter when actuated;
a coin cell battery adapted to provide voltage to the audible indicator to allow for actuation of the audible indicator; and
a microtransformer coupled to the coin cell battery and the audible indicator such that voltage derived from the coin cell battery is transformed to provide sufficient voltage to the audible indicator to provide at least 80 decibels of sound at one meter; and
a transmitter adapted to be utilized by a parent to actuate the receiver unit in order to locate the child, wherein the transmitter comprises:
an actuation button which can be depressed by the parent to actuate the audible indicator of the receiver unit;
a signal creation module to generate a signal to be transmitted to the receiver antenna of the receiver unit.

22. The child locator system of claim 21, wherein the housing includes an ornamental design to promote wearing of the receiver unit by a child.

23. The child locator system of claim 21, wherein the microtransformer comprises a microcoil.

24. The child locator system of claim 21, wherein the transmitted signal is encoded to prevent receipt of signals from a transmitter of another child locator system.

25. The child locator system of claim 21, wherein the receiver unit includes an anti-tamper device which prevents removal of the receiver unit from the child without actuating an audible signal from the audible indicator.

26. The child locator system of claim 25, wherein the transmitter further comprises an on/off switch configured to turn off the anti-tamper device to allow the parent to remove the receiver unit from the child without actuating the audible signal from the audible indicator.

27. The child locator system of claim 21, wherein the child locator system includes one or more secondary receiver units.

28. The child locator system of claim 27, wherein the transmitter can separately actuate each of the receiver units.

29. The child locator system of claim 28, wherein a separate actuation button is provided for each receiver unit.

30. The child locator system of claim 29, further comprising a toggle capability to allow the actuation button to actuate different receiver units.

31. The child locator system of claim 30, wherein each of the receiver units includes an audible indicator and wherein the audible indicators of each of the receiver units is provide with a different audible signal to allow a parent to determine the location of different children by differentiating between different receiver units.

32. A method of utilizing a child locator system to identify the location of a child in a home or public environment, the child locator system having a transmitter to allow a parent to send a signal to actuate the receiver unit and the receiver unit to provide an alarm in response to transmission of the signal from the transmitter of the child locator system, the receiver unit comprising:
providing a transmitter for generating a signal to determine the location of a child;
providing a receiver unit for receiving the signal from the transmitter;
actuating a signal generation mechanism at the transmitter;
transmitting the signal from the transmitter to the receiver unit;
processing the signal received at the receiver unit from the transmitter utilizing a microcontroller;
transforming battery power from a coin cell battery utilizing a transformer to provide at least 20 volts of electricity;
actuating an audible indicator utilizing the at least 20 volts of electricity to provide at least 80 decibels of sound at one meter;

33. The method of claim 32, wherein the audible indicator provides at least 90 decibels of sound at one meter.

34. The method of claim 32, wherein the transformer comprises a microcoil.

35. The method of claim 34, wherein the microcoil provides a turn ratio of at least one to seven.

36. The method of claim 35, wherein the microcoil provides a one to ten turn ratio.

37. The method of claim 36, wherein the coin cell battery comprises an at least one volt coin cell battery.

38. The method of claim 36, The method of claim 36, wherein the coin cell battery comprises an at least 2.5 volt coin cell battery.

39. The method of claim 37, wherein the microcoil provides at least 30 volts from the coin cell battery.
